(19) United States
(12) Patent Application Publication
(10) Pub. No.: US 2016/0304033 A1
(43) Pub. Date: Oct. 20, 2016

(54) CASE OF PORTABLE ELECTRONIC DEVICE AND VEHICLE APPARATUS HAVING THE CASE THEREOF

(71) Applicant: LEAUTO INTELLIGENT TECHNOLOGY (BEIJING) CO.LTD, Beijing (CN)

(72) Inventor: Fuquan WANG, Beijing (CN)

(21) Appl. No.: 14/971,804

(22) Filed: Dec. 16, 2015

(30) Foreign Application Priority Data
Apr. 14, 2015 (CN) 201520224660.8

(51) Int. Cl. B60R 11/02

(52) U.S. Cl. CPC B60R 11/02; B60R 2011/0294

(57) ABSTRACT

The present disclosure is related to a case of a portable electronic device and a vehicle apparatus having the case. A bottom shell of the case of a portable electronic device has engaging portions disposed on a first lateral surface and a second lateral surface respectively, such that the portable electronic device can be alternatively combined to the vehicle holder of the vehicle apparatus by the engaging portion on the first lateral surface or by the engaging portion on the second lateral surface. Thus, it has both a right-handed operation mode and a left-handed operation mode. Thereby, users can choose different operation modes according to their needs and it is more user friendly.

### CROSS-REFERENCE TO RELATED APPLICATION

This application claims priority under 35 U.S.C. §119(a) to Patent Application No(s). 201520224660.8, filed in China on Apr. 14, 2015, the entire contents of which are hereby incorporated by reference.

### FIELD OF TECHNOLOGY

The present disclosure is related to a portable electronic device, and more particularly, to a case of a portable electronic device and a vehicle apparatus having the case thereof.

### BACKGROUND

In order to assemble a portable electronic device, such as a cell phone, a tablet computer, a navigation device or other vehicle wireless communication devices (such as a vehicle Bluetooth device) in a vehicle for providing information to the driver, such as incoming calls, navigation paths, driving messages or handsfree calls, the industry has developed a vehicle rack of a portable electronic device.

In general, the vehicle rack includes a base and a fixing unit connected with the base, wherein an accommodating space is formed in the base for accommodating the portable electronic device, and the fixing unit is usually a sucker, an elastic band or clamping brackets fixed by screws, when the vehicle rack is in use, the vehicle rack can be attached to the windshield of the vehicle by the sucker, the vehicle rack can be fixed to the steering wheel by the elastic band, or the vehicle rack can be can be clamped to the steering wheel by the clamping bracket, such that the used can dispose the portable electronic device around the driver's seat.

Currently, only right-handed operation condition is considered for the assembly of the portable electronic device and the vehicle rack, for example, the portable electronic device can be combined to the base of the vehicle rack in a single direction. Meanwhile, the operation interface of the portable electronic device, such as the display screen or the operation buttons, are disposed at the right side of the vehicle rack, which is suitable for right-handed operation.

However, when the holder of the vehicle rack is moved to the left side of the user, the operation interface of the portable electronic device is still disposed at the right side of the vehicle rack, which is not user friendly to left-handed users. in operation, the interference between the operation interface and the hand would cause misoperations.

### SUMMARY

The present disclosure provides a case of a portable electronic device and a vehicle apparatus having the case, so as to solve the problem that when using portable electronic devices with vehicle racks, it is unfriendly for left-handed users and is prone to misoperations during left-handed operations.

In order to solve the above problem, the present disclosure provides a case of a portable electronic device, adapted for a vehicle holder. The case of a portable electronic device includes a bottom shell, and the bottom shell has a first lateral surface and a second lateral surface opposite to each other. Engaging portions are disposed on the first lateral surface and the second lateral surface respectively. The bottom shell is combined to the vehicle holder through the engaging portions on the first lateral surface for achieving a right-handed operation mode or alternatively is combined to the vehicle holder through the engaging portions on the second lateral surface for achieving a left-handed operation mode.

In one embodiment, in the above mentioned case of a portable electronic device, the engaging portions are two notches disposed with intervals, and each of the notches has a vertical passage and a horizontal passage connected with each other.

In one embodiment, in the above mentioned case of a portable electronic device, the bottom shell further includes an accommodating groove and a cover, the accommodating groove is configured for accommodating a battery, and the cover covers the accommodating groove; wherein the cover further includes a slot disposed at the side opposite to the accommodating groove. The length of the slot is shorter or equal to the diameter of the battery, and the width of the slot matches the thickness of the battery.

In one embodiment, the above mentioned case of a portable electronic device further includes a front shell and an operation panel, the front shell latches to the other side of the bottom shell opposite to the cover by a fastener, and the operation panel is combined to the front shell and shields the fastener.

The present disclosure further provides a vehicle apparatus, comprising a portable electronic device and a vehicle holder. The portable electronic device includes the case. The case has a first lateral surface and a second lateral surface opposite to each other, and engaging portions are disposed on the first lateral surface and the second lateral surface respectively. The vehicle holder has supporting portions, and the supporting portions and the engaging portions are concave and convex structures matching with each other. Wherein, the portable electronic device is combined to the supporting portions of the vehicle holder by the engaging portions on the first lateral surface for achieving a right-handed operation mode or alternatively is combined to the supporting portions of the vehicle holder by the engaging portions on the second lateral surface for achieving a left-handed operation mode.

In one embodiment, in the above mentioned vehicle apparatus, the engaging portions are two notches disposed with intervals, and each of the notches has a vertical passage and a horizontal passage connected with each other.

In one embodiment, in the above mentioned vehicle apparatus, the bottom shell further includes an accommodating groove and a cover, the accommodating groove is configured for accommodating a battery, and the cover covers the accommodating groove; wherein the cover further includes a slot disposed at the opposite side of the cover. The length of the slot is shorter or equal to the diameter of the battery, and the width of the slot matches the thickness of the battery.

In one embodiment, in the above mentioned vehicle apparatus, the case of a portable electronic device further includes a front shell and an operation panel, the front shell latches to the other side of the bottom shell opposite to the cover by a fastener, and the operation panel is combined to the front shell and shields the fastener.

In one embodiment, in the above mentioned vehicle apparatus, the supporting portions of the vehicle holder are two bolts disposed with intervals, the two bolts correspond to the two notches disposed on the case, each of the supporting portions has a long edge connecting with a short edge by way of bending connection, and each of the supporting portions is embedded into the vertical passage and the horizontal passage of each of the notches.

In one embodiment, in the above mentioned vehicle apparatus, the vehicle holder includes a main body, a fixing bracket and a joint body. The main body has an opening and the supporting portions. One end of the fixing bracket is connected by way of bending connection with the one side of the main body adjacent to the opening, and a stopper is disposed at the other end of the fixing bracket. The joint body includes a head end and a tail end opposite to each other, the head end is connected with the fixing bracket, and the tail end alternatively passes through the opening and is fixed to the stopper of the fixing bracket. Wherein, when the tail end passes through the opening, one side of the joint body disposed at the main body curls and forms an annular structure, and the tail end is capable of reciprocating relative to the stopper and adjusting the inner diameter of the annular structure.

As compared with present technologies, the present disclosure can achieve the following technical effects. According to the case of a portable electronic device and the vehicle apparatus provided in the present disclosure, engaging portions are disposed at the first lateral surface and the second lateral surface of the bottom shell, which are opposite to each other, such that the user can select the engaging portion on the first lateral surface or the engaging portion on the second lateral surface so as to combine to the vehicle holder, which are suitable for both right-handed mode and left-handed mode. Therefore, whether the vehicle holder is disposed at the left side or the right side of the user in the car, the vehicle holder can be switched between the left-handed mode and the right-handed mode for providing an appropriate operation mode of the portable electronic device to the user, which is more convenient, and it can avoid the misoperations occurred during an inappropriate operation mode. In addition, the cover, which covers the accommodating groove on the bottom shell, has notches with suitable sizes to the size of the battery, such that the cover can be taken off by a new battery when replacing the battery, and after replacing the old battery, the lacking operation can be achieved by the old battery, which is convenient to the users.

### BRIEF DESCRIPTION OF THE DRAWINGS

In order to more clearly illustrate the embodiments of the present disclosure, the accompanying drawings for illustrating the technical solutions and the technical solutions of the present disclosure are briefly described as below. In the drawings:

FIG. 1 is an exploded view of a vehicle apparatus according to the embodiment the present disclosure;

FIG. 2 is a combinational view of a vehicle apparatus according to the embodiment the present disclosure;

FIG. 3 is a sectional view of a vehicle holder according to the embodiment the present disclosure;

FIG. 4 is an exploded view of a portable electronic device according to the embodiment the present disclosure;

FIG. 5 is a partial and exploded view of a portable electronic device according to the embodiment the present disclosure;

FIG. 6 is a combinational view of a portable electronic device according to the embodiment the present disclosure;

FIG. 7 is a partial and exploded view in another view of a portable electronic device according to the embodiment the present disclosure; and

FIGS. 8-10 are schematic views of a portable electronic device in using status according to the embodiment the present disclosure.

### DESCRIPTION OF THE EMBODIMENTS

The following description with reference to the accompanying drawings is provided to clearly and completely explain the exemplary embodiments of the present disclosure. The process of realization that how the present disclosure uses the technology to solve technical problems and reaches the technical effects can be fully understood and implemented accordingly.

As used in the specification and claims, certain terms are used to refer to specific components. The person skilled in the art will appreciate that manufacturers may use different terms to refer to the same component. This specification and the claims do not differentiate the name as a way to distinguish between the components, but differentiate in the function of the component as a criterion to distinguish. As mentioned throughout the specification and claims, in which the “comprising” is an opening term, it should be interpreted as “including but not limited to.” “Approximately” means within an acceptable error range. Those skilled in the art solves the problem within a certain error range and substantially achieves the technical effect. In addition, “coupled” as used herein contains any direct and indirect electrical coupling means. Therefore, if the text describes a first device coupled to a second device, it means that the first device is directly electrically coupled to the second device or indirectly electrically coupled to the second device by other devices or coupled means. Subsequent description described in the present disclosure is for the implementation of the preferred embodiment, and then the description of the present disclosure is for explanation of the general principles, and is not intended to limit the scope of the present disclosure. The protection scope of the present disclosure is depended on the appended claims and their equivalents.

It is further noted that the term “comprising”, “including” or any other variation thereof, are intended to cover a non-exclusive inclusion, such that commodity or systems containing a series of factors not only include those elements, but also include other elements not explicitly listed, or also includes inherent elements for such commodity or systems. Without more constraints, elements defined by the statement “includes a . . . ” do not exclude the existence of additional identical elements in the element comprising the commodities or system.

### Embodiments

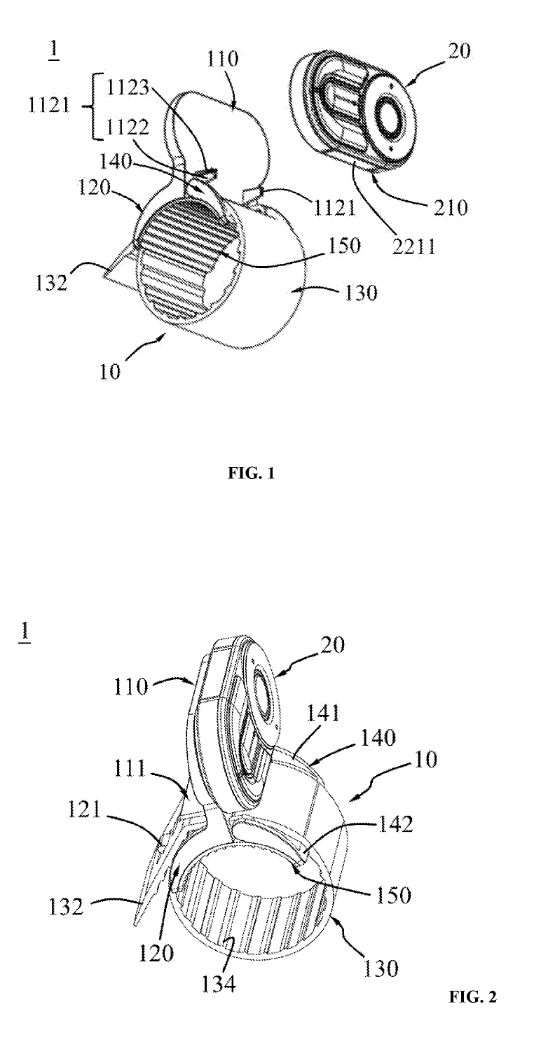

As shown in FIG. 1, according to the embodiment of the present disclosure, a vehicle apparatus 1 includes a vehicle holder 10 and a portable electronic device 20, wherein the portable electronic device 20 can be a cell phone, a tablet, a navigation device or other vehicle wireless communication equipment (such as vehicle Bluetooth devices). In this embodiment, the portable electronic device is described as vehicle Bluetooth device, but the present disclosure is not limited thereto.

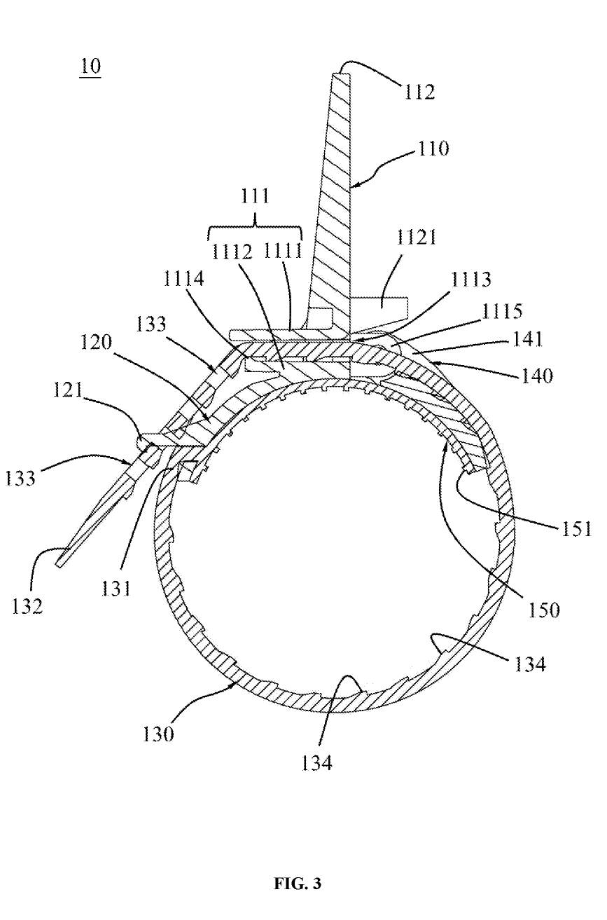

Referring to FIG. 1 to FIG. 3, the vehicle holder 10 includes a main body 110, a fixing bracket 120 and a joint body 130, wherein the main body 110 and the fixing bracket 120 can be integrally formed, but the present disclosure is not limited thereto, for example, the main body 110 and the fixing bracket 120 can be integrally formed by injection molding plastics; the material of the joint body 130 can be rubber or silicone, but the present disclosure is not limited thereto.

The main body 110 has a bottom base 111 and a carrier board 112, wherein the bottom base 111 includes a top board 1111 and a bottom board 1112, the top board 1111 supports the bottom board 1112, and the top board 1111 and the bottom board 1112 form an opening 1113 passing through the bottom base 111 therebetween. The carrier board 112 rises on the top board 1111 of the bottom base 111, and supporting portions are disposed on the carrier board 112, the supporting portions 1121 can be strip structures or flake structures, such as hooks or blocks, extending from the surface of the carrier board 112, or slots sunken from the surface of the carrier board 112, configured for combing with engaging portions of the portable electronic device 20. Wherein the supporting portions 1121 of the carrier board 112 and the engaging portions 210 of the portable electronic device 20 can be concave and convex structures matching with each other. In this embodiment, the supporting portions 1121 are described as structures, such as hooks, blocks and so forth, extending from the surface of the carrier board 112, but the present disclosure is not limited thereto. One end of the supporting portions 1121 is connected with one side of the surface of the carrier 112 adjacent to the opening 1113, and the supporting portions extend along the axial direction of the opening 1113, wherein the extending direction of the supporting portions 1121 are reverse to the extending direction of the bottom base 111, i.e. the top board 1111 of the bottom base 111 and the bottom board 1112 of the bottom base 111 extend along the direction away from the supporting portions 1121, such that the bottom base 111 and the supporting portions 1121 extend toward two opposite sides of the carrier board 112. It can be realized that, in other embodiments of the present disclosure, the bottom base 111 and the supporting portions 1121 can extend along identical direction and are disposed at the same side of the carrier board 112, which is not limited by the description.

The fixing bracket 120 bends along the direction of form the top board 1111 of the bottom base 111 toward the bottom board 1112 and forms a curved structure, wherein one end of the fixing bracket 120 is connected to one side of the main body 110 adjacent to the opening 1113, such as connecting to the bottom board 1112 of the bottom base 111, such that the opening 1113 of the bottom base 111 is exactly disposed between the fixing bracket 120 and the carrier board 112. The other end of the fixing bracket 120 extends along the direction away from the supporting portions 1121 of the carrier board 112, and a stopper 121 is disposed at the other end of the fixing bracket 120. The stopper 121 is disposed at one side of the fixing bracket 120 opposite to the bottom base 111, the stopper 121 can be, but not limited to, a hook, a protrusion protruding from the surface of the fixing bracket 120 or a Velcro attaching on the surface of the fixing bracket 120, configured for fixing the joint body 130 to the fixing bracket 120 temporarily.

The joint body 130 includes a head end 131 and a tail end 132 opposite to each other, the head end 131 is connected with the fixing bracket 120, for example, the head end 131 is connected with one end of the fixing bracket 120 having the stopper 121; the tail end 132 swing freely at the other side of the bottom base 111 of the main body 110, which is opposite to the carrier board 112, and the tail end 132 can alternatively pass from one end of the opening 1113 of the bottom base 111, which is corresponding to the supporting portions 1121, toward the other end of the opening 1113, such that part of the joint body 130 is clamped between the top board 1111 of the bottom base 111 and the bottom board 1112, and one side of the joint body 130 disposed at the main body 110 curls and forms an annular structure. In addition, when the tail end 132 of the joint body 130 passes through the opening 1113, the tail end 132 of the joint body 130 is capable of reciprocating relative to the stopper 121 of the fixing bracket 120 so as to select the position of the tail end 132 fixing to the stopper 121 for adjusting the inner diameter of the annular structure. Wherein the tail end 132 of the joint body 130 has a fixing portion 133, the fixing portion 133 and the stopper 121 of the fixing bracket 120 are fixing structures matching with each other, and they can combine with each other in detachable means. For example, when the stopper 121 of the fixing bracket 120 is a Velcro attaching on the surface of the fixing bracket 120, the fixing portion 133 disposed at the tail end 132 is a corresponding Velcro; when the stopper 121 of the fixing bracket 120 is a hook or a protrusion protruding from the surface of the fixing bracket 120, the fixing portion 133 of the tail end 132 is a corresponding positioning hole.

In this embodiment, the stopper 121 of the fixing bracket 120 is described as a hook, and the fixing portions 133 disposed at the tail end 132 is described at a plurality of positioning holes, but the present disclosure is not limited thereto. The plurality of positioning holes is arranged with intervals along the curling direction of the joint body 130, i.e. the plurality of positioning holes is arranged with intervals along the circumferential direction of the annular structure formed by the joint body 130. Therefore, when the tail end 132 of the joint body 130 moves relative the stopper 121 of the fixing bracket 120, one of the position holes can be engaged with the stopper 121, such that the stopper 121 passes through the positioning hole and is engaged to the positioning hole, and the tail end 132 of the joint body 130 is temporarily fixed to the fixing bracket 120 and the movement of the tail end 132 is restricted. In addition, by the way of the tail end 132 of the joint body 130 reciprocating relative to the stopper 121 of the fixing bracket 120, the inner diameter of the annular structure, which is formed by the joint body 130, can be adjusted. In other words, annular structures with different radii of inner diameters can be formed by the stopper 121 engaging with different positioning holes. Thereby, the vehicle holder 10 can be assembled in different types of vehicles, e.g., by adjusting the inner diameter of the annular structure, the joint body 130 can be bound to the steering wheel in a car or the car pole of a bicycle, such that the usage of the vehicle holder 10 is more flexible.

Referring to FIG. 1 to FIG. 3 and FIG. 10, in application, the vehicle holder 10 of the embodiment of the present disclosure is adapted for fixing the portable electronic device 20 to the vehicle. First, the base 111 of the main body 110 is disposed at a suitable rigid bracket 30, such as the steering wheel or other rod structures, and the curved structure of the fixing bracket 120 attaches the surface of the rigid bracket 30 as more as possible. Then, the tail end 132 of the joint body 130 passes through the opening 1113 on the bottom base 111 and forces the joint body 130 elastic deforming, surrounding the outer periphery of the rigid bracket 30 and forming an annular structure at the rigid bracket 30. Wherein, accompanied with the tail end 132 of the main body 130 moving toward the stopper 121 of the fixing bracket 120 continuously, the inner diameter of the annular structure gradually narrows toward the rigid bracket 30, and when the joint body 130 attaches the rigid bracket 30, one of the positioning hole of the fixing portions 133 disposed at the tail end 132 exactly corresponds to the stopper 121 of the fixing bracket 120 and is engaged to the stopper so as to stop the movement along the direction of the elastic recovery of the joint body 130 and pulls the tail end 132 for fixing to the fixing bracket 129 so as to prevent the joint body 130 loosing from the rigid bracket 30. Thus, the vehicle holder 10 can be firmly and safely fixed to the rigid bracket 30. At the moment, the portable electronic device can be firmly combined to the supporting portions 1121 of the main body 110 by the engaging portions 210. By the arrangement, it can prevent the problem of the vehicle holder 10 from loosing or dropping so as to achieve a better user experience.

The above description describes the installation of the vehicle device 10, similarly, when disassembling the vehicle holder 10, the tail end 132 of the joint body 130 is pulled toward the direction of the fixing bracket 120, such that the fixing portions 133 at the tail end 132 leaves the stopper 121 of the fixing bracket 120, then the tail end 132 moves toward the direction of the opening 1113 by the elastic recovery of the joint body 130, afterwards, the tail end 132 is pulled out from the opening 113 and the disassembling of the vehicle holder 10 is completed. Therefore, it is very simple to install and disassemble the vehicle holder 10, and the user experience can be improved.

In addition, in the embodiments of the present disclosure, assisting structures can be alternatively disposed on the vehicle holder for improving the stability. For example, a plurality of anti-slip members 134 is disposed at one side of the joint body 130 opposite to the fixing bracket 120, the plurality of anti-slip members 134 protrudes from the surface of the joint body 130, and the plurality of anti-slip members 134 is arranged with intervals from the head end 131 of the joint body 130 toward the tail end 132 of the joint body 130. Wherein when the joint body 130 curls and forms the annular structure, the plurality of anti-slip members 134 is positioned on the inner wall of the annular structure, such that when the joint body 130 attaches the rigid bracket in the vehicle, the top surfaces of the anti-slip members 134 can increase the bending angle of the joint body 130 corresponding to the rigid bracket, such that the top surface of the anti-slip members 134 can attach the surface of the rigid bracket and the friction therebetween can be increased, and the main body 110 and the fixing bracket 120 can be more firmly combined to the rigid bracket.

Further, in order to reduce the gaps between the joint body 130 and the rigid bracket, a movable bracket 140 is disposed at the main body 110 or a pad 150 is disposed at the joint body 130, or alternatively a movable bracket 140 is disposed at the main body 110 as well as a pad 150 is disposed at the joint body 130. The followings describe the functions of the movable bracket 140 and the pad 150 respectively.

One end of the movable bracket 140 is pivotally connected with the main body 110, and the other end is capable of reciprocating relative the joint body 130, and when the tail end 132 of the joint body 130 passes through the opening 1113 of the bottom base 111, the movable bracket 140 corresponds to the inner wall of the annular structure and abuts the inner wall of the annular structure or is away from the inner wall. Wherein when the joint body 130 attaches the rigid bracket in the vehicle, the joint body 130 brings the moveable bracket 140 rotating along the direction of the rotary axis and adjusting the attaching strength of the movable bracket 140 corresponding to the rigid bracket so as to attach the rigid bracket. Meanwhile, the rigid bracket pushes the movable bracket 140 abutting the inner wall of the annular structure formed by the joint body 130, such that the gaps between the joint body 130 and the rigid body is decreased, the contact area therebetween is increased, and the friction therebetween is increased, which is beneficial to the stability.

Similarly, disposing the pad 150 at the head end 131 of the joint body 130 can achieve the effect of decreasing the gaps between the joint body 130 and the rigid bracket as well as increasing the stability. The pad 150 is connected with the head end 131 of the joint body 130, and the pad 150 is disposed at the fixing bracket 120 opposite to the other end of the main body 110, wherein the two opposite ends of the pad 150, preferably, stretch across the two opposite sides of the main body 110, and correspond to the stopper 121 of the fixing bracket 120 and the supporting portions 1121 of the carrier board 112. Meanwhile, the pad 150 bend toward the main body 110 and form a curved surface, wherein when the joint body 130 curls and forms the annular structure, the curved surface of the pad 150 corresponds to the inner wall of the annular structure. Therefore, when the joint body 130 attaches to the rigid bracket in the vehicle, the curved surface of the pad 150 attaches the surface of the rigid bracket, such that the friction therebetween is increased. In addition, a plurality of ribs 151 is disposed on the curved surface of the pad 150. The plurality of ribs 151 is disposed on the curved surface of the pad 150 and is arranged with intervals along the circumferential direction of the annular structure for increasing the strength of the pad 150 and increasing the grasping force of the pad 150 in the surface of the rigid bracket.

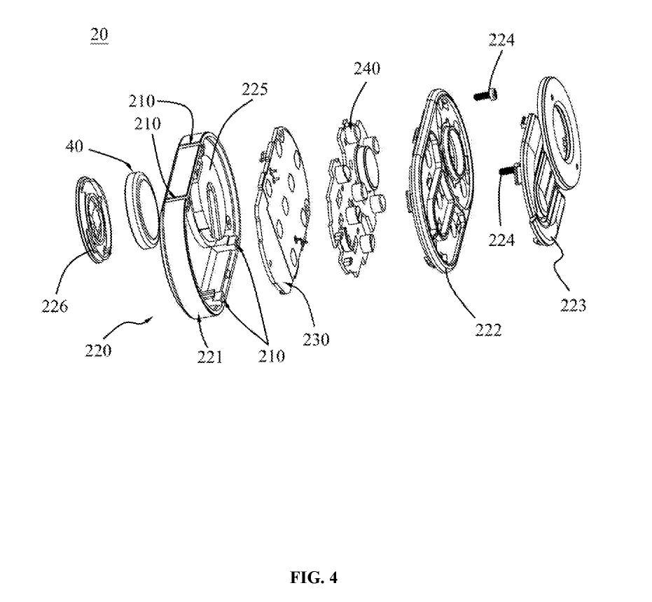

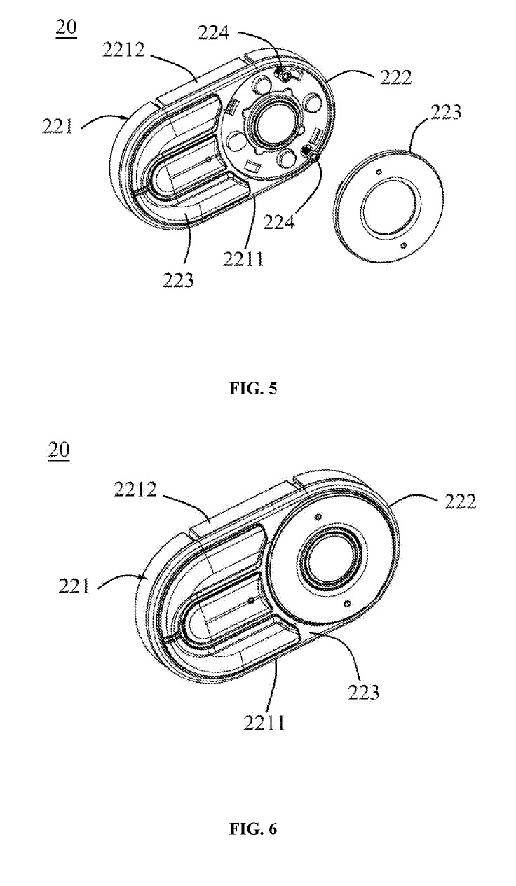

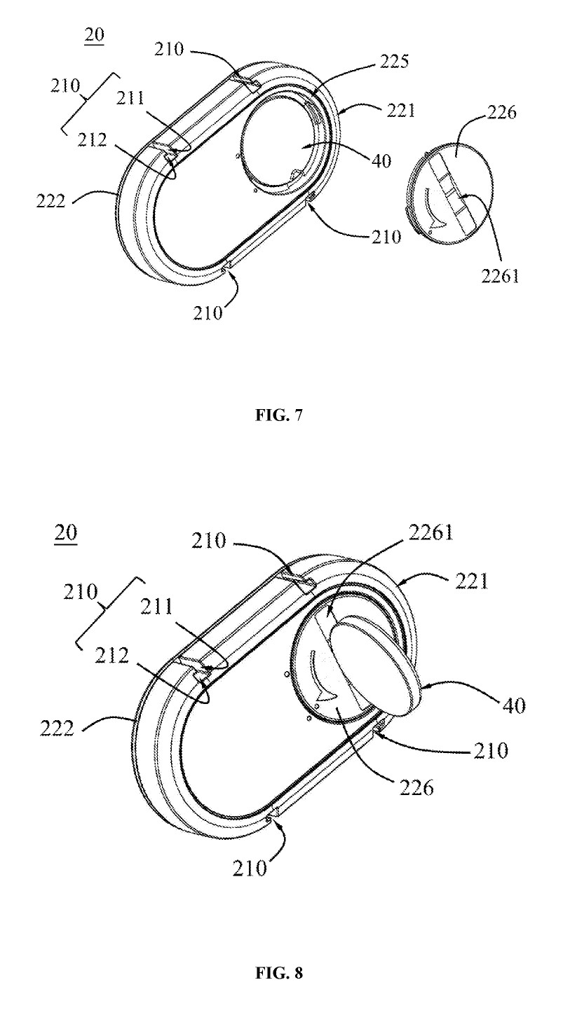

Referring to FIG. 4 to FIG. 8, the portable electronic device 20 includes a case 220 and a circuit board 230 and a button module 240 disposed in the case 220. The case 220 includes a bottom shell 221, a front shell 222 and an operation panel 223. The front shell 222 latches to the other side of the bottom shell 221 by a fastener 224, such that the circuit board 230 and the button module 240 are covered between the bottom shell 221 and the front shell 222. After the fastener 224 latches the front shell 222, the operation panel 223 is combined to the front shell 222 by screws or engaging. Wherein the combination method can be, but not limited to, disposing concave and convex structures at the operation panel 223 and the front shell 222 respectively, for example, a hook is disposed at the edge of the operation panel 223, and a corresponding slot is disposed at the front shell 222, and the hook is engaged in the slot by pressing, such that the operation panel 223 is combined to the front shell 222 and the operation panel 223 shields the fastener 224 (as shown in FIG. 5 and FIG. 6), thus the appearance of the case 220 can be remained smoothly and consistently. In addition, an accommodating groove 225 and a cover 226 are further disposed at the bottom shell 221. The accommodating groove 225 is configured for accommodating a battery 40. The cover 226 covers the accommodating groove 225, shields the accommodating groove battery 40, and the cover 226 and the surface bottom shell 221 are co-planar. Wherein the cover 226 further includes a slot 2261 disposed at the lateral surface opposite to the accommodating groove 225. The structure of the slot 2261 matches the structure of the battery 40. For example, when the battery is a button battery, the length of the slot 2261 is shorter or equal to the diameter of the battery 40, and the width of the slot 2261 matches the thickness of the battery 40. Thus, when one needs to replace the battery 40, one can use the battery 40 as a spanner for embedding a new battery into the slot 2261 forcing the cover 226 rotating clockwise and leaving the bottom shell 221 (as shown in FIG. 7 and FIG. 8) for replacing the old battery in the accommodating groove 225 by a new battery. In addition, after replacing the battery, the cover 226 can be rotated, tightened and fixed to the bottom shell 221 counter-clockwise by embedding the old battery into the slot 2261. Therefore, it is more convenient to replace the battery 40 by the above structure.

It should be noted that, in this embodiment, the bottom shell 221 has a first lateral surface 2211 and a second lateral surface 2212 opposite to each other. Engaging portions 210 are disposed on both the first lateral surface 2211 and the second lateral surface 2212. The structure of the engaging portions 210 matches the supporting portions 1121 of the vehicle holder 10. For example, the engaging portions 210 and the supporting portions 1121 are concave and convex structures matching with each other. In this embodiment, the engaging portions 210 are described as two notches disposed with intervals, and are described as the supporting portions 1121 are two bolts disposed with intervals and correspond to the two notches, but the present disclosure is not limiter thereto. Wherein, each of the notches of the engaging portions 210 has a vertical passage 211 and a horizontal passage 212 connected with each other. Each of the supporting portions 1121 has a long edge 1122 connecting with a short edge 1123 by way of bending connection. When the portable electronic device 20 is combined to the vehicle holder 10 by the engaging portions 210 engaging with the supporting portions 1121, the long edge 1122 and the short edge 1123 of the supporting portions 1121 are embedded into the vertical passage 211 and the horizontal passage 212, such that the stability of the combination is increased.

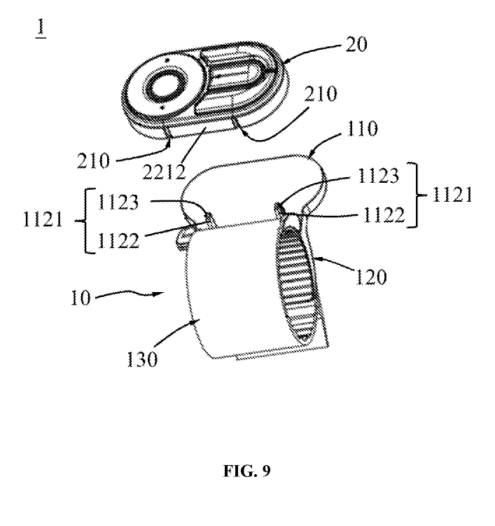

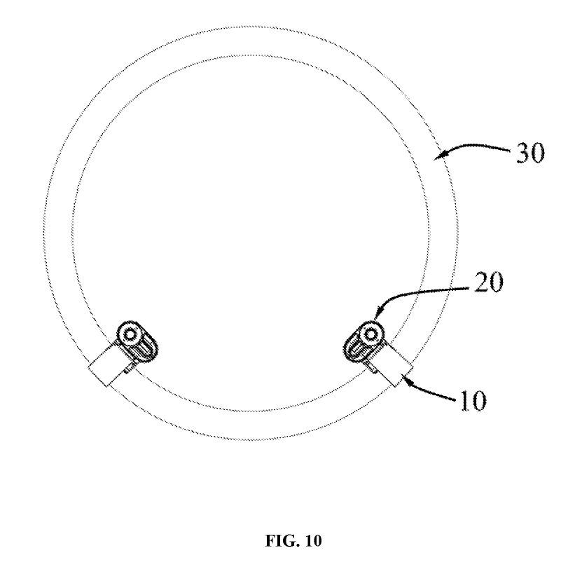

Referring to FIG. 1, FIG. 2, FIG. 9 and FIG. 10, further, since the two opposite sides of the bottom shell 221 has the engaging portions 210, for the combination of the portable electronic device 20 and the vehicle holder 10, one can combine the engaging portions 210 on the first lateral surface 2211 to the vehicle holder 10 for achieving a right-handed operation mode (as shown in FIG. 2) or alternatively combine the engaging portions 210 on the second lateral surface 2212 to the vehicle holder 10 for achieving a left-handed operation mode (as shown in FIG. 9). Thus, the vehicle apparatus 1 has both the right-handed mode and the left-handed mode. Since it is simple to detach the portable electronic device 20 from the vehicle holder 10, one can instantly change the operation mode according to their needs wherever the portable electronic device 20 is fixed to the rigid bracket 30 by the vehicle holder 10. Thus, it can be in the status suitable for the user, and the practicability of the portable electronic device 20 and the vehicle apparatus 1 is increased.

Note that the specifications relating to the above embodiments should be construed as exemplary rather than as limitative of the present disclosure. The equivalent variations and modifications on the structures or the process by reference to the specification and the drawings of the present disclosure, or application to the other relevant technology fields directly or indirectly should be construed similarly as falling within the protection scope of the present disclosure.

What is claimed is:

1. A case of a portable electronic device, adapted for a vehicle holder, comprising:
a bottom shell, having a first lateral surface and a second lateral surface opposite to each other;
engaging portions disposed on the first lateral surface and the second lateral surface respectively;
wherein the bottom shell is combined to the vehicle holder through the engaging portions on the first lateral surface for achieving a right-handed operation mode or alternatively is combined to the vehicle holder through the engaging portions on the second lateral surface for achieving a left-handed operation mode.

2. The case of a portable electronic device according to claim 1, wherein the engaging portions are two notches disposed with intervals, and each of the notches has a vertical passage and a horizontal passage connected with each other.

3. The case of a portable electronic device according to claim 1, wherein the bottom shell further comprises an accommodating groove and a cover, the accommodating groove is configured for accommodating a battery, and the cover covers the accommodating groove; wherein the cover further comprises a slot disposed at the side opposite to the accommodating groove, the length of the slot is shorter or equal to the diameter of the battery, and the width of the slot matches the thickness of the battery.

4. The case of a portable electronic device according to claim 3, wherein further comprising a front shell and an operation panel, the front shell latches to the other side of the bottom shell opposite to the cover by a fastener, and the operation panel is combined to the front shell and shields the fastener.

5. A vehicle apparatus, comprising:
a portable electronic device, comprising the case according to any one of claims 1 to 4; and
a vehicle holder, having supporting portions, the supporting portions and the engaging portions being concave and convex structures matching with each other;
wherein the portable electronic device is combined to the supporting portions of the vehicle holder by the engaging portions on the first lateral surface of the case for achieving a right-handed operation mode or alternatively is combined to the supporting portions of the vehicle holder by the engaging portions on the second lateral surface of the case for achieving a left-handed operation mode.

6. The vehicle apparatus according to claim 5, wherein the supporting portions are two bolts disposed with intervals, the two bolts correspond to the two notches disposed on the case, each of the supporting portions has a long edge connecting with a short edge by way of bending connection, and each of the supporting portions is embedded into the vertical passage and the horizontal passage of each of the notches.

7. The vehicle apparatus according to claim 5, wherein the vehicle holder comprises:
a main body, having an opening and the supporting portions;
a fixing bracket, one end of the fixing bracket is connected by way of bending connection with the one side of the main body adjacent to the opening, and a stopper is disposed at the other end of the fixing bracket; and
a joint body, comprising a head end and a tail end opposite to each other, the head end is connected with the fixing bracket, the tail end alternatively passes through the opening and is fixed to the stopper of the fixing bracket;
wherein, when the tail end passes through the opening, one side of the joint body disposed at the main body curls and forms an annular structure, and the tail end is capable of reciprocating relative to the stopper and adjusting the inner diameter of the annular structure.

8. The vehicle apparatus according to claim 7, wherein a plurality of positioning holes is disposed at the tail end of the joint body, the plurality of positioning holes is arranged with intervals along the curling direction of the joint body, the stopper of the fixing bracket engages with one of the plurality of positioning holes, and when the stopper engages with different positioning holes, the joint body curls and forms the annular structure with different inner diameters.

9. The vehicle apparatus according to claim 7, wherein a plurality of anti-slip members is disposed at one side of the joint body opposite to the fixing bracket, the plurality of anti-slip members is arranged on the surface of the joint body with intervals from the head end toward the tail end, and when the joint body curls and forms the annular structure, the plurality of anti-slip members is positioned on the inner wall of the annular structure.

10. The vehicle apparatus according to claim 7, wherein the vehicle apparatus further comprises a movable bracket, one end of the movable bracket is pivotally connected with the main body, and the other end is capable of reciprocating relative to the inner wall of the annular structure so as to abut the inner wall or is away from the inner wall.

11. The vehicle apparatus according to claim 7, wherein the joint body further comprises a pad connected with the head end, the pad is disposed at the fixing bracket opposite to the other end of the main body, wherein the two opposite ends of the pad stretch across the two opposite sides of the main body, bend toward the main body and form a curved surface, and the curved surface corresponds to the inner wall of the annular structure.
